(19) United States
(12) Patent Application Publication
(10) Pub. No.: US 2014/0051408 A1
(43) Pub. Date: Feb. 20, 2014

(54) METHOD AND SYSTEM FOR COUPLING A MOBILE DEVICE TO AN OUTPUT DEVICE

(71) Applicants: Stefan Jenzowsky, Wien (AT); Markus Placho, Schwechat (AT)

(72) Inventors: Stefan Jenzowsky, Wien (AT); Markus Placho, Schwechat (AT)

(21) Appl. No.: 14/001,192

(22) PCT Filed: Mar. 16, 2012
(86) PCT No.: PCT/EP2012/054651

§ 371 Date: Oct. 24, 2013

(30) Foreign Application Priority Data
Mar. 18, 2011 (AT) A 386/2011

(51) Int. Cl. H04W 4/00; H04W 76/02

(52) U.S. Cl. CPC H04W 4/001; H04W 76/023
USPC 455/414.1

(57) ABSTRACT

A method for coupling a mobile device to an output device is proposed. The mobile device is used to control a selection and/or output of data contents provided via a cellular communication network. The mobile device initiates a coupling component via the cellular communication network. The coupling component determines the output device based on a stored, user-specific environment pattern and dynamically couples the output device to the mobile device. A system has a mobile device to control a selection and/or output of data contents and an output device and a cellular communication network which provides the data contents. A coupling component determines the output device to be coupled based on a store, user-specific environment pattern and couples the output device to the mobile device.

### TECHNICAL FIELD

The present invention relates generally to the field of communications and multimedia technology, and to the transmission and output of data contents, in particular so-called over-the-top contents. Specifically, the present invention relates to a method and a system for coupling at least one mobile device to at least one output device, in particular a screen unit. The mobile device is used to control a selection and/or output of data contents in this case, said data contents being provided via a cellular communication network.

### PRIOR ART

The capacity of mobile devices, particularly so-called smartphones and tablet PCs, has developed considerably in recent years. A so-called smartphone is usually a mobile phone which, normally by means of additional programs (known as apps), provides more computer functionality and connectivity than a conventional mobile phone. A so-called tablet PC is a portable personal computer (PC) which is similar to a laptop and can be used without a keyboard. In this case, operation normally takes place directly on a generally capacitive touch-sensitive screen, either using an input stylus or a finger (e.g. by means of so-called multi-touch gestures). Such mobile devices (e.g. smartphones, tablet PCs, etc.) can be carried and transported easily, and can enable the current user to connect to e.g. the Internet via e.g. a mobile radio network, wireless LAN, etc. while on the move or from any location.

At the same time, the technical capabilities and/or properties of television devices or TV sets have been extended and improved. By virtue of so-called external set-top boxes or integrated units, television devices today are able to use the Internet via the television device and/or consume television programs directly via the Internet as so-called IP-TV. This capability extends from a simple connection to the Internet to technologies such as e.g. browsers that are integrated into the television device for the purpose of displaying data contents from the Internet, or facilities that can be linked to the TV set and via which television-specific applications can be procured and downloaded in exchange for payment. At the same time, so-called video-on-demand is also being influenced by such developments. While access to data contents (e.g. multimedia data, in particular audio and/or video data) and output thereof on the television device or TV set was previously based on standardized methods of transmission for digital contents such as e.g. Digital Video Broadcasting (DVB), transmission of the data contents to the television device or TV set is now based on so-called Internet Protocol Television (IP-TV). In the case of IP-TV, the Internet is normally used as a transmission medium for films and television programs, and also for video-on-demand.

These developments also make so-called over-the-top (OTT) content possible. This is normally understood to mean an online transfer of data contents (e.g. multimedia data, video contents, audio contents, etc.), wherein no Internet Service Provider is involved in monitoring and/or distribution of the data contents. The data contents are usually provided by large media companies and can be downloaded by the user from a simple Web site or an environment based on the Internet protocol (IP), thereby initiating a so-called OTT data delivery from the so-called IP cloud, i.e. from an abstract IP-based infrastructure.

It is therefore possible for users to access e.g. OTT data contents or video-on-demand environments via various output devices (e.g. smartphones, tablet PCs, television devices, etc.). Also important today is the ability to display and play downloaded data contents in a flexible manner in this case, i.e. as required on a corresponding output device. On the one hand, it should be possible to play or display data contents on e.g. a display unit of a mobile device such as e.g. a smartphone, etc. On the other hand, it should be possible to display the data contents (when available) on a large-surface output device (e.g. TV screen) if a corresponding output device is available or if the user is staying at home, for example. This means that it is important for users of OTT data contents to transfer the display of data contents back and forth between output devices, possibly while said data contents are being viewed/played.

However, selecting contents is also a relatively complex challenge for the user in a modern television environment. Not only are numerous (usually several hundred) channels available for selection by television users, but numerous additional data contents such as e.g. multimedia data, audio and/or video contents are also offered for selection by users of so-called video-on-demand environments. In this case, it must be possible for desired channels and/or data contents to be searched and selected quickly and easily by the user in such an OTT television environment. In this case, quick and easy selection of the data contents is largely dependent on a presentation of the data contents and/or channels on an output device (in particular a screen unit) and on a correspondingly effective utilization of the output device or screen area.

It is easier and more enjoyable for a user to make a selection, for example, if said user can peruse and process a plurality of selectable data contents and television channels, or offers of selectable data contents and/or television channels, during a predefined selection period. In this case, it is crucial to display a corresponding number of offers of selectable data contents and/or television channels in an appropriate overview on the output device, and to offer the user a corresponding means of navigating through the presentation of the data contents and/or channels.

For the purpose of navigating through the data contents and/or television channels on offer, and selecting the desired data content or television channel, various approaches may be employed depending on the output device in use. If e.g. a television device or a TV set is used as an output device, a remote control which is specifically connected to the output device via infrared is normally used to navigate through television channels and/or data contents or to select the desired channels or data contents. Alternatively, it is also possible to link a remote control via wireless LAN, for example, or to use a so-called smartphone as a remote control for a television device as an output device by means of the so-called VooMote concept, which represents a special facility for smartphones and by means of which a smartphone can be transformed into a smart universal remote control. In this case, the keypad of the relevant remote control is normally used to peruse the data contents and/or television channels offered on the output device. In this case, for example, the keypad is used to control a so-called cursor on a presentation interface of the OTT data contents or television channels as displayed on the output device, in order to browse through the contents presented and select the desired data contents, etc.

If e.g. a personal computer is used as an output device for presentation of the OTT data contents, navigation and/or selection can take place via a keyboard and/or so-called computer mouse. A cursor is then moved through the contents and a selection is made by means of the movements of the computer mouse, for example. Most tablet PCs have a normally capacitive touch-sensitive screen (so-called touchscreen). If tablet PCs are therefore used for the presentation and selection of data contents, browsing through the presented data contents and selection are performed by means of an input stylus and/or a finger, for example, or using so-called multi-touch gestures.

However, it is not only necessary to consider the different controls for navigating through data contents and/or television channels on the output devices, but also the different screen areas available. The screen area can vary from relatively large (e.g. television screen) to relatively small (e.g. display on a smartphone). The user is therefore offered not only different control options, but also a display of the selectable data contents that is dependent on the screen area available in each case. This means that the user is restricted, depending on the output device, to a predefined type of navigation and/or a specific mobile device (e.g. remote control, etc.) for controlling the browsing through the offer of data contents, and also that the presentation of the data contents depends on the respective output device.

In order to configure a selection of data contents more simply and/or clearly for the user, user-specific behavior can be taken into consideration when presenting the data contents or television channels. For example, user-specific preferences, television viewing behavior, usage patterns, etc. can be used in this case. In addition to user-specific limitations in respect of the data contents offered, however, a personalized experience is also essential when browsing through or perusing data contents, as is correspondingly simple and intuitive operation when selecting data contents, particularly in the field of OTT offers.

This presents a number of problems when requesting and displaying so-called OTT offers or OTT data contents:
If data contents are provided as OTT offers, they are available via the Internet, i.e. in the so-called IP cloud. This means that the data contents (e.g. audio contents, video contents, etc.) may be consumed at any desired location on any desired output devices having various display areas and properties, without this being known when the data contents are offered. However, this results in different presentation of the data contents and it may be necessary for the user to learn a new way of navigating through the data contents.
In the case of specific data contents such as e.g. video contents, it may be beneficial for the user to be able to switch back and forth between different output devices. This naturally requires a coupling between different output devices and/or mobile devices which can be used for the selection of data contents. However, a direct connection does not usually exist between the various mobile devices (e.g. smartphone, tablet PC, etc.) and output devices (in particular screen units) employed by a user. For example, smartphones or tablet PCs do not have an infrared connection by means of which they can be connected to e.g. a television device.
It is often important to users that their output devices and mobile devices should be connected automatically and without great effort (e.g. installation, etc.). Particularly if said devices are in close proximity, it should be possible to effect an automatic and reliable coupling or decoupling with ease.
It should also be easy for the user to interact (e.g. browse through data contents, select data contents and/or television channels, etc.), and use OTT offers on different output devices in parallel, for example.
When displaying OTT data contents, it is also important that a display of selected data contents should not be disrupted by unwanted data contents and/or previously used data contents. Measures should also prevent users from being unintentionally presented with unsuitable contents (e.g. age-restricted contents, etc.).
It is also important for a presentation of the OTT data contents or the selection of the data contents to be adapted according to the properties of the selected output device (e.g. available screen area, etc.).

At present, e.g. mobile devices for controlling the selection and output of data contents (e.g. remote control) are specifically coupled (e.g. via infrared, wireless LAN, etc.) to the output device. The user is therefore unable to decide freely which mobile device will be used in combination with which output device to control a selection and to output data contents. Switching or rerouting the output of the selected data contents to a more suitable output device (e.g. selection on the smartphone and display on a television device, etc.) is therefore likewise impossible.

Alternatively, entertainment systems also exist which are based on specifications from the Digital Living Network Alliance (DLNA). The DLNA is an international alliance of manufacturers of computers, entertainment electronics and mobile telephones, whose objective is to ensure the interoperability of information technology devices from different manufacturers in private use. In this case, however, problems can always arise e.g. in the context of presentation and selection if e.g. specific data formats, etc. are not supported by individual devices in the system.

A further possibility available to the user for coupling an output device to a mobile device as a control unit is e.g. an indirect coupling of these devices via a specific background function. However, this approach has the disadvantage that the same specific background function must be employed by both the output device and the mobile device in use. This means that the user has to use devices originating from the same manufacturer. Flexibility for the user is therefore significantly reduced, since mobile devices can only be coupled to output devices of one manufacturer, and those devices which the user wishes to couple must be procured from a single manufacturer. It is therefore not possible to effect a coupling of any desired output devices to any desired mobile devices from different manufacturers. Furthermore, such an indirect coupling via a specific background function cannot be integrated in the case of any desired OTT data content offers, thereby significantly restricting the selection possibilities open to a user.

### Statement of the Invention

The object of the invention is therefore to specify a method and a system by means of which any desired mobile devices can be used in a simple and flexible manner in combination with at least one freely selected output device for the purpose of controlling, selecting and displaying data contents that are provided via a cellular communication network, wherein both the mobile devices and the output device can originate from any desired manufacturer.

This object is achieved by a method and a system of the type cited in the introduction, having the features according to the independent patent claims. Advantageous embodiments of the present invention are described in the dependent claims.

According to the invention, the object is achieved by a method of the type cited in the introduction, in which a coupling component is initiated via the cellular communication network by at least one mobile device. On the basis of a stored user-specific environment pattern, the at least one output device to be coupled is then determined by the coupling component (CDE) and a coupling to the at least one mobile device is dynamically implemented.

The main aspect of the solution proposed according to the invention is that various mobile devices (e.g. smartphone, tablet PC, etc.) of a user can be coupled dynamically, flexibly and automatically to at least one output device of the user (e.g. television device, TV set) via a cellular communication network (e.g. Internet) by means of a coupling component. On the basis of a stored user-specific environment pattern, the coupling component recognizes which output device of the user can be coupled, or must be decoupled, and when this should occur, e.g. when a mobile device is located in the vicinity of the output device. Mobile devices and output devices being used need not originate from the same manufacturer in this case. The user can ideally use devices from any desired manufacturer for the coupling.

By virtue of the coupling, the at least one mobile device can easily be employed by the user to control the selection and/or output of the data contents, and utilized in the same way as a remote control for the output device. It is additionally possible either to switch back and forth between different output devices (e.g. television, smartphone display or tablet PC display) with ease (e.g. by means of multi-touch movements, etc.) as required, or to use the two output devices in parallel, for example. For example, it is therefore possible to display a program overview, selectable data contents, etc. on a display of the mobile device, while e.g. previously selected data content is displayed on the output device. As a further facility, the method according to the invention also allows a combination of television advertising with so-called direct-response advertising. In this case, in addition to being offered advertising contents on the output device (e.g. TV screen, television device, etc.), the user is also offered additional possibly interactive data contents (e.g. auto-configurator, coupon request option, etc.) on an output unit of the coupled mobile device (e.g. smartphone display, tablet PC display, etc.) without thereby disturbing the output on the output device.

The method according to the invention also allows optimal utilization of an available display area, i.e. a screen of a television device, a smartphone display or a tablet PC display, for example. The data contents that are presented for selection and/or output can also be adapted to the respective output device, since the coupling component can analyze not only screen areas of output devices, but also transmission capacities for data contents such as e.g. bandwidth, pixel size, high-definition playback capacities, etc. accordingly. Therefore data contents provided via the cellular communication network, in particular over-the-top contents, can quickly and easily be viewed, selected and optimally displayed on any desired available output device by a user, without the need to learn a new means of navigation.

In this case, provision is advantageously made for the at least one mobile device to determine a current environment pattern for the purpose of initiating the coupling component and specifying the at least one output device that is to be coupled, and for the proximity specification unit of the coupling component then to estimate a proximity between the at least one mobile device and the at least one output device on the basis of parameters of said current environment pattern. In this simple way, it is possible to ensure that only mobile devices and output devices having a certain spatial proximity relative to each other are coupled together. This therefore prevents a user using a mobile device from inadvertently activating another output device which does not have a specific spatial proximity (e.g. located in the same room, etc.) to the mobile device.

So-called fuzzy-logic methods and/or probability reckoning models are appropriately used by the proximity specification unit to estimate the proximity between the devices on the basis of parameters. Since a rapid specification is important for time-efficient coupling, only a few parameters are used by the proximity specification unit for this specification, and estimations are made in order to obtain a rapid result. Using fuzzy-logic models or probability reckoning models, good indications can quickly be obtained in respect of a spatial proximity between one or more mobile devices and at least one output device, said devices belonging to a coupling scenario, for example. By virtue of the proximity specification unit, the coupling component therefore establishes quickly and efficiently whether the mobile device is close to (e.g. in the same room as) an output device that is to be coupled. A coupling can therefore be implemented without lengthy waiting times for the user, or an existing coupling can be checked without disrupting an output of data contents, for example.

In order to obtain a further proximity estimate having greater accuracy, or in the event that an estimation result of the proximity specification unit is e.g. too inaccurate, a pattern recognition unit of the coupling component can advantageously specify a degree of correspondence of the parameters of the current environment pattern to the user-specific environment pattern that is stored in the coupling component. On the basis of the degree of correspondence determined by the pattern recognition unit, it is easy to establish automatically whether a mobile device is located in the vicinity or range of an output device of the user, and control errors can therefore be avoided very efficiently. A coupling between a mobile device and an output device may then be implemented only if a specific and predetermined degree of correspondence is achieved, for example. If a renewed check of the coupling establishes that the degree of correspondence is insufficient, the coupling can be terminated automatically.

A renewed check may be provoked by e.g. a trigger by means of which the coupling component is initiated. Possible triggers include e.g. a timer (time, date), the detection of a movement of the mobile device, changes in signal strengths (e.g. wireless LAN field strength, etc.), detection of a change in position of the mobile device (e.g. by means of a global positioning system), a user input, etc. Provision is likewise made for first estimating a proximity between the devices in this case, wherein a degree of correspondence between a current environment pattern and a stored user-specific environment pattern is determined if this result is too inaccurate. The proximity specification unit and the pattern recognition unit work closely together in this case, particularly when couplings are created, rechecked or terminated. So-called fuzzy logic methods are also advantageously used by the pattern recognition unit for the purpose of determining the degree of correspondence.

For the purpose of estimating a proximity and/or determining the degree of correspondence, provision is ideally made for a field strength of wireless LAN and/or Bluetooth, a transmitter identification of wireless LAN and/or Bluetooth, an audible audio signal and/or an inaudible audio signal in particular to be used as parameters of the current environment pattern. Alternatively, optical environment parameters which are captured by e.g. an integrated camera of the mobile device, position data of the mobile device as determined by means of e.g. a global positioning system or via a mobile radio network in which the mobile device is registered, etc. can be used for the purpose of determining the degree of correspondence to the stored user-specific environment pattern.

If audio signals are employed to establish the proximity between mobile device and output device, e.g. a special audio signal is sent from the coupling component to the output device, and ambient noise is then picked up by e.g. a microphone of the mobile device. If e.g. the special transmitted audio signal is recognized in the ambient noise, this is a reliable indication that the mobile device is located in the vicinity of the output device (e.g. in the same room). Alternatively, it is also possible simply to capture a rendition of audio portions of a rendition of data contents using the mobile device, for example, and compare it with the audio portions that are output by the output device, in order to check a proximity between mobile device and output device or an existing coupling, for example.

In an appropriate embodiment of the method according to the invention, the at least one output device to be coupled is registered with an associated user-specific environment pattern by means of a registration unit of the coupling component. In this way, the user can easily notify the coupling component of at least one frequently used output unit and/or the associated environment pattern. This user-specific environment pattern associated with the at least one output device to be coupled can then be saved in a pattern recognition database of the coupling component. This means that the stored user-specific environment pattern can always be retrieved quickly and used by the pattern recognition unit of the coupling component to create a coupling to a mobile device and/or to check a coupling (e.g. whether this coupling should be preserved or whether the mobile device has already been removed from the vicinity of the output device). An output unit to be coupled is registered once by a user via the registration unit of the coupling component, and the associated environment pattern (e.g. wireless LAN identification and/or Bluetooth identification, signal strength of wireless LAN and/or Bluetooth, optical environment parameters, etc.) is captured and saved in the pattern recognition database of the coupling component. The pattern recognition database can also be used to store parameters of environment patterns or complete environment patterns of previous coupling scenarios of a user, and associated proximity estimation results and/or degree of correspondence results of these coupling scenarios accordingly. As a result, a coupling element can then very quickly recognize whether e.g. a previously known coupling scenario already exists in the case of a coupling operation between a mobile device and an output device.

In a further advantageous development, a status of the coupling between the at least one mobile device and the at least one output device to be coupled is saved in a coupling status unit of the coupling component. As a result, the coupling component can easily establish whether a coupling exists between a mobile device and an output device. If a coupling does not already exist, creation of a coupling can automatically be initiated if a mobile device comes into the vicinity of an output device, for example. If an existing coupling is present, it is possible to check whether this should be preserved, for example, or whether the mobile device is no longer in the vicinity of the output device and the coupling should therefore be disconnected.

In a preferred development of the method according to the invention, provision is made for a security unit of the coupling component to initiate an additional check of the coupling between the at least one mobile device and the at least one output device in the case of specific data contents, particularly age-restricted data contents. As a result, it is easy to ensure that e.g. specific data contents such as e.g. age-restricted contents are only output if the user who selected these data contents via the mobile device is in the immediate vicinity of the output device. If applicable, the check of the coupling between the output device and the mobile device can be started by increasing or decreasing threshold values for e.g. a trigger which provokes the check and is based on age-related approvals. For example, if the data contents are approved for ages of 18 years and above, the highest or lowest threshold value (depending on the threshold value selected) is used when checking the coupling and, for example, a check is always performed in the case of such contents. In the case of data contents for ages of 16 years and above, or a lower approved age rating, the threshold value for the check can be selected lower or higher accordingly.

Furthermore, provision is advantageously made for the coupling component to check, by means of an input device checking unit, whether an input device (in particular a remote control) is present for the at least one output device. As a result, it can easily be established whether an alternative input device such as e.g. a remote control which is directly connected to the output device via infrared is used for inputs (e.g. volume adjustment, channel selection, etc.) in addition to the mobile device for controlling the output device, for example.

Provision is also advantageously made for the coupling component to check, via an authorization interface, authorizations relating to a procurement of data contents. By means of the authorization interface, the coupling component can establish e.g. on the basis of authorization and/or authentication data (e.g. user data, credit card data, user name, password, etc.) whether a user is e.g. registered or authorized by a provider of over-the-top contents to procure specific data contents such as e.g. chargeable video data. Any unauthorized procurement of data contents can therefore be prevented easily.

The object of the invention is further achieved by a system of the type cited in the introduction, said system being designed to perform the method according to the invention, wherein a coupling component for specifying the at least one output device to be coupled is provided such that, on the basis of a stored user-specific environment pattern, the at least one output device to be coupled can be specified and a coupling to the at least one mobile device can be generated dynamically.

The main aspect of the system according to the invention is that various mobile devices (e.g. smartphone, tablet PC, etc.) of a user can be coupled dynamically, flexibly and automatically to at least one output device of the user (e.g. television device, TV set) via a cellular communication network (e.g. Internet) by means of the coupling component. Any desired mobile devices and output devices can be used by the user in this case, i.e. devices of any desired manufacturers are coupled by the coupling component and the coupling component is therefore manufacturer-independent and therefore offers the user a high degree of flexibility.

In this case, the coupling component can take the form of e.g. a component which is available in the cellular communication network, wherein said component can be contacted by the mobile devices and output devices to be coupled, or has facilities that take the form of so-called executable applications (on the mobile devices and output devices) or connections (e.g. web links) to the coupling component, for example. A contact to the coupling component can therefore be created quickly and irrespective of location, and a coupling can be generated between the mobile devices and the output devices automatically and without resource-intensive user interaction on the basis of a stored user-specific environment pattern. The user can then use a mobile device to control the selection and/or output of data contents in a conventional manner or using conventional navigation means. The output of the data contents can also be adapted by the coupling component to the properties of the output device (e.g. available screen area, bandwidth, pixel size, high-definition playback capabilities, etc.). Available output devices (e.g. television device, smartphone display, tablet PC display) can also be used in parallel for the presentation of data contents. For example, a smartphone display can be used to display an overview of data contents and to navigate through data contents (e.g. displaying an electronic program overview, etc.), while selected data content (e.g. video data) is displayed in parallel on a television device. Additional information (e.g. product information, etc.) relating to data content that is playing on the output unit can also be requested on the display of the mobile device, for example.

The coupling component advantageously comprises a trigger unit which is initiated for the purpose of generating the coupling, a proximity specification unit for estimating a proximity between mobile devices and output devices, and a pattern recognition unit for comparing the stored user-specific environment pattern with parameters of an environment pattern that is currently identified by the at least one mobile device. By virtue of the trigger unit, it is possible automatically to start a creation of a coupling between a mobile device and an output device or to check an existing coupling, e.g. on the basis of parameters such as e.g. a timer (e.g. time, date, etc.), a position of a mobile device, a movement of the mobile device (detected using e.g. integrated sensors such as e.g. accelerometer, gyroscope, etc.), changes in signal strengths (e.g. wireless LAN field strength, etc.) or a user input. Using the proximity specification unit, a spatial proximity between a mobile device and an output device is then easy to estimate on the basis of parameters relating to the currently ascertained environment pattern, e.g. by means of fuzzy logic or probability reckoning methods. An indication is therefore very quickly obtained in respect of whether a mobile device and an output device belong to e.g. the same coupling scenario, i.e. can be coupled, by virtue of a corresponding spatial proximity (e.g. being in the same room).

In order to estimate more accurately whether the mobile device is located in the vicinity of an output device, a degree of correspondence can then be specified by the pattern recognition unit on the basis of parameters of the stored user-specific environment pattern, which is compared with the parameters of the current environment pattern as ascertained by the mobile device. Cascaded interworking between proximity specification unit and pattern recognition unit prevents a coupling from being created to a remote output device. This ensures that the output device having corresponding proximity (i.e. being in the same room, for example) is coupled to the mobile device in each case. At the same time, a coupling between a mobile device and an output device can be terminated automatically if the mobile device is removed from the vicinity of the output device.

According to an appropriate development of the inventive system, the coupling component comprises a registration unit for registering output devices to be coupled, and a pattern recognition database for saving associated user-specific environment patterns. By virtue of the registration unit, output devices to be coupled can be registered, with associated user-specific environment patterns, in order to allow quick and simple coupling by the coupling component. The pattern recognition database is then used to store and quickly retrieve the user-specific environment patterns. When creating or checking a coupling, the pattern recognition database can then easily provide a user-specific environment pattern of the respective output device to the proximity specification component for comparison with the parameters of the current environment pattern ascertained by the mobile device. The pattern recognition database can also be used to store parameters of environment patterns or complete environment patterns of previous coupling scenarios of a user, and associated proximity estimation results and/or degree of correspondence results of these coupling scenarios accordingly.

The coupling component ideally comprises a coupling status unit for saving a status of the coupling. This can quickly identify whether there exists between a mobile device and an output device a coupling which must be checked in respect of its currency and must possibly be terminated, or whether a coupling between a mobile device and an output device must be created.

According to a preferred embodiment of the inventive system, the coupling component also comprises a security unit for initiating an additional check of the coupling in the case of specific data contents, in particular age-restricted data contents, an input device checking unit for checking the presence of additional input devices (in particular a remote control) belonging to the respective output device, and an authorization interface for checking authorizations for a procurement of data contents.

The coupling can be subjected to an additional check by means of the security unit if specific data contents, particularly age-restricted data contents, are selected. In this way, it is easy to ensure that e.g. specific data contents such as e.g. age-restricted contents are only output if the user who selected these data contents via the mobile device is in the immediate vicinity of the output device. It is therefore very easy to prevent the specific data contents from being displayed due to an accidental coupling of a mobile device to an output device or due to a coupling that is erroneously present.

The input device checking unit establishes whether an alternative input unit such as e.g. an input unit which is directly connected to the output device (e.g. an infrared remote control) is present and is also used e.g. to control the output device (e.g. volume adjustment, channel change, etc.).

The authorization interface allows the coupling component to check in a simple manner whether a user is authorized to procure data contents (e.g. chargeable contents, etc.), e.g. from a provider of these data contents. To this end, user-specific authorizations can be checked on the basis of e.g. authorization and/or authentication data (e.g. user data, credit card data, user name, password, etc.). The data contents are displayed to the user on the output device only after a successful check, and an unauthorized procurement of data contents is therefore prevented.

A mobile device which can be used to control the selection and/or output of data contents advantageously takes the form of a so-called smartphone, a so-called tablet PC and/or a laptop in particular. These devices are easy to transport and can therefore easily be moved into the vicinity of the output device by the user. In addition, such devices are usually linked to a cellular communication network, in particular the Internet, and their operation (e.g. via keypad, touchscreen, etc.) is familiar to the user. These devices also feature a display, which can easily display information that is used to control a selection and/or output of data contents.

An output device, in particular for displaying the data contents, advantageously takes the form of a screen unit of a TV device, a so-called smartphone, a so-called tablet PC or a laptop. If a television device or TV set or the associated screen is used as an output unit, data contents can be displayed clearly and in good quality (e.g. video data). Additional use of screen units such as e.g. smartphone displays, tablet PC displays, etc. offers the possibility of switching back and forth between the output units. It is thus possible to continue viewing data contents even if the user moves away from a location-fixed output unit (e.g. television device, etc.). It is possible to switch seamlessly between the output devices without disrupting the data output, using a form of navigation that is customary for the output device concerned. Using the displays of mobile devices such as e.g. smartphones, tablet PCs, etc. also allows a parallel output of different data contents, such that e.g. a program overview or a preview of further data contents, etc. can be displayed on the smartphone or tablet PC while e.g. a video film continues to play without disruption on the screen of the television device. A user can seamlessly and automatically use supplementary information relating to selected data contents, e.g. meta-information, additional information, additional data offers, etc.), without thereby disrupting output and playback of data content that has been selected.

In particular, the Internet is advantageously used as a cellular communication network. It is then easy to request various data contents (so-called over-the-top contents) from different providers without great effort.

### BRIEF DESCRIPTION OF THE DRAWING

The invention is explained schematically and in an exemplary manner below with reference to the appended figures. By way of example,

FIG. 1 in this case schematically shows both an execution of the inventive method and the system for implementing the inventive method, wherein the system includes a schematic over-the-top infrastructure for the provision of data contents.

FIG. 2 schematically exemplifies a detailed structure of the system according to the invention, in particular a coupling component.

### PERFORMANCE OF THE INVENTION

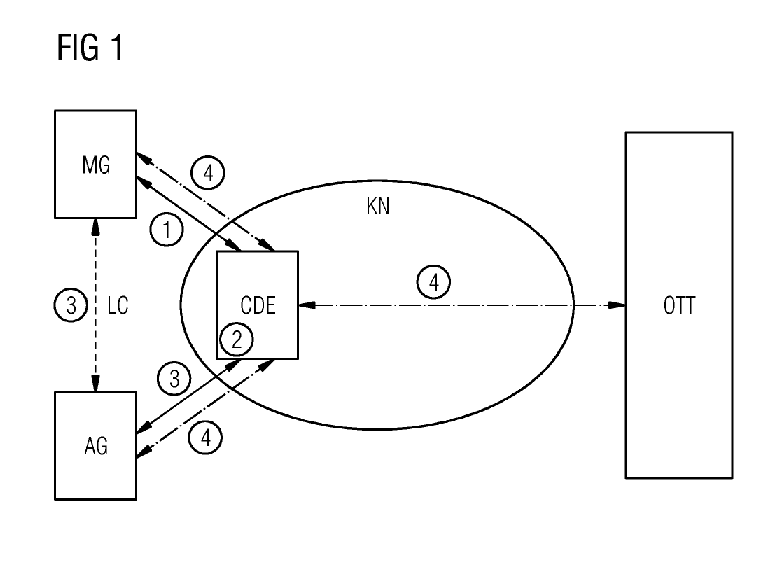

FIG. 1 schematically exemplifies the system for implementing the method according to the invention. The inventive system in this case comprises at least one mobile device MG such as e.g. a smartphone, a so-called tablet PC or laptop, etc. The at least one mobile device MG is provided for the purpose of controlling a selection and/or output of data contents in this case. In this case, the mobile device MG is intended to be used like a remote control, for example, on which selectable data contents such as e.g. videos, etc. are displayed and can be selected by the user in a manner that is customary for the mobile device MG concerned, e.g. by means of keypad, touchscreen, mouse, etc.

The system according to the invention further comprises at least one output device AG such as e.g. a screen unit, a television device, a so-called media box with display screen, etc. The data contents selected by the user are then displayed on the output device AG. A cellular communication network KN is provided for the purpose of delivering the data contents, in particular so-called over-the-top contents. In this case, the Internet in particular is provided as a cellular communication network KN via which data contents can be procured from any desired OTT providers as so-called over-the-top content. Such OTT providers of data contents comprise e.g. video-on-demand stores, television suppliers who also provide video and/or audio contents via a cellular communication network KN or the Internet, etc., or a provider who offers data contents or a database containing data contents online.

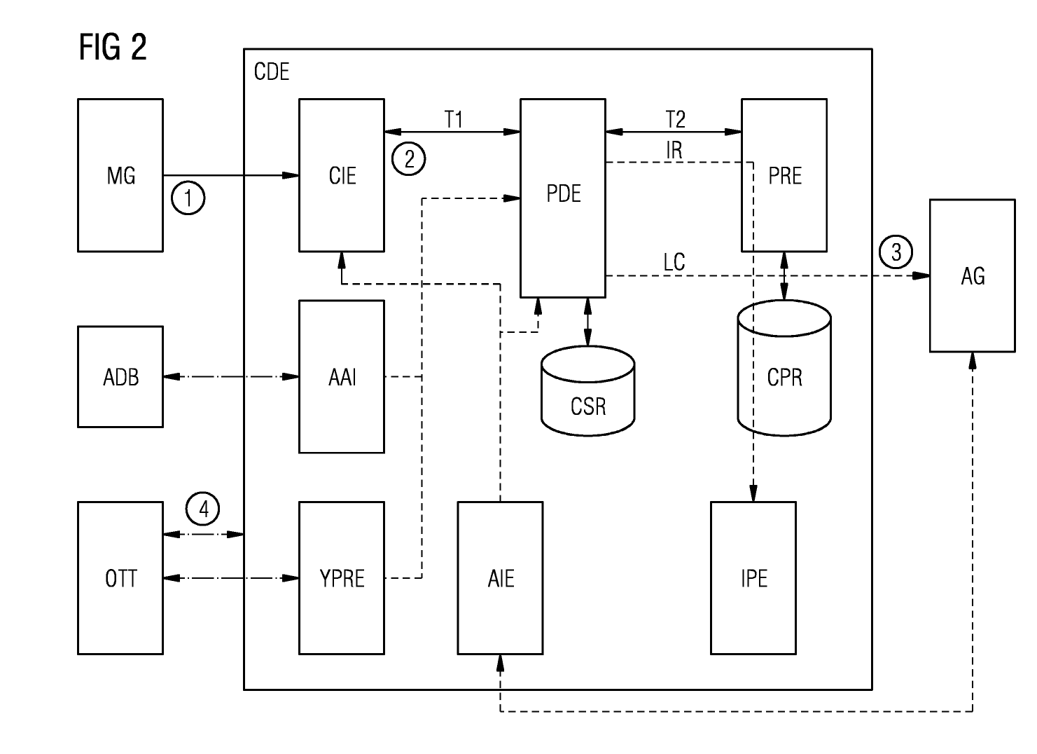

The system according to the invention further comprises a coupling component CDE, which is provided for the purpose of specifying the at least one output device AG to be coupled. In this case, the coupling component CDE is so embodied that, on the basis of a stored user-specific environment pattern, the at least one output device AG to be coupled can be specified and is dynamically coupled to the at least one mobile device MG. The coupling component CDE is a component of the inventive system for decision making and, as schematically exemplified in FIG. 2, comprises a set of units by means of which is it possible to decide whether two or more mobile devices MG should be coupled to one or more output devices AG. The coupling component CDE then specifies a representation of the data contents (e.g. number of data units shown, etc.) and options that are available to the user according to the relevant output device AG (e.g. screen, smartphone display, tablet PC display, etc.) in this case. Responses of all devices MG, AG participating in a coupling scenario are therefore directed by the coupling component CDE. The coupling component CDE can therefore initialize and validate a coupling LC or a decoupling of a mobile device MG and an output device AG.

In this case, the coupling component CDE can be embodied e.g. as an executable facility in the cellular communication network KN, which facility can be selected by the mobile device MG and optionally also by the output device AG, for example, e.g. by means of a so-called web link. However, it is also possible for the coupling component to be embodied as a so-called application or app which runs at least partly on the mobile device MG and/or on the output device AG if applicable. An embodiment of the coupling components CDE as a so-called pseudo-app is also conceivable.

The inventive method for dynamically coupling at least one mobile device MG to at least one output device AG, said method being implemented by the exemplary system illustrated schematically in FIG. 1, begins with a first method step 1. In the first method step 1, a coupling component CDE is initiated by a mobile device MG (e.g. smartphone, tablet PC, etc.) via a cellular communication network KN such as e.g. the Internet. In this case, the coupling component CDE can be a selectable and executable facility within the cellular communication network KN (e.g. a web site or web link). However, the coupling component CDE can also be embodied such that it runs partly as an application (so-called app) or so-called pseudo-app on the mobile device MG, or also on an output device AG to be coupled. Once a dynamic coupling LC is established, these applications or pseudo-apps can then interact via a selectable and executable facility within the communication network KN. In this case, the application part of the coupling component CDE can be downloaded onto the relevant mobile devices MG and output devices AG or these devices MG, AG can be registered with the coupling component CDE in the context of a once-only initialization and/or registration procedure, for example.

In a second method step 2, the at least one output device AG to be coupled is specified by the coupling component CDE on the basis of a stored, user-specific environment pattern. In this case, a current environment pattern is determined by the mobile device MG, for example, and then an estimation of a proximity between the mobile device MG and the output device AG to be coupled is performed on the basis of parameters of the current environment pattern such as e.g. field strengths of wireless communication networks and/or data transmission standards (e.g. wireless LAN, Bluetooth, etc.), transmitter identifications of wireless LAN, Bluetooth, etc., audible audio signals, inaudible audio signals, optical signals (e.g. optical patterns, etc.). In particular, fuzzy logic and/or probability reckoning methods are employed for the purpose of such proximity estimation. The proximity estimation in the coupling component CDE is ideally performed in a cascaded manner in this case, i.e. a proximity between mobile device MG and output device AG is initially estimated on the basis of a few parameters from the current environment pattern, and further parameters and/or pattern comparisons are used if the proximity estimate is inadequate.

If the proximity estimate is too inaccurate or the output device AG to be coupled cannot be determined therefrom, the coupling component CDE can compare parameters of a current environment pattern with the stored user-specific environment pattern, for example. On the basis of this comparison, a degree of correspondence is then estimated using fuzzy logic methods, for example, and it is then decided whether a mobile device MG should be coupled to an output device AG, i.e. the two devices MG, AG have a corresponding proximity relative to each other and there is no danger that another (remote) output device AG will be inadvertently or unintentionally controlled by the mobile device MG.

For example, an environment pattern which is associated with the respective output device of a user and was stored during the initialization and/or registration procedure can be used as a stored user-specific environment pattern. However, for the purpose of the comparison, it is also conceivable to use environment patterns of a user which are known from previous e.g. successful coupling operations. The coupling component CDE makes use of stored information in this case. Such information comprises e.g. situation-specific parameters (e.g. audio signals, optical data, field strengths, etc.), which are known from previous coupling scenarios.

If an adequate proximity between the mobile device MG and the output device AG is ascertained by the coupling component CDE in the second method step 2 as a result of a proximity estimation and/or an estimation of a degree of correspondence between stored and current environment patterns, a coupling LC between the mobile device MG and the output device AG to be coupled is implemented dynamically and automatically in a third method step 3. In this case, the coupling LC can be automatically terminated again at any time, particularly if the mobile device MG is moved away from the output device AG.

Once the coupling LC between mobile device MG and output device AG has been established, e.g. data contents can be requested from a provider OTT via the cellular communication network KN in a fourth method step 4 and the output of these data contents on the output device AG can be controlled by the mobile device MG. In this case, a display of the data contents can be influenced by the coupling component CDE as a function of the mobile device MG and/or output device AG, for example. Therefore an overview, selection, etc. of the data contents requested from a provider OTT can be shown on a display of the mobile device MG for the purpose of control, while the data content itself (e.g. video data, etc.) is presented on the output device AG, for example. In this case, the options available to the user can also be controlled by the coupling component CDE as a function of the mobile device MG and/or output device AG.

For example, so-called video covers or video trailers can be shown to a user on the mobile device MG (e.g. smartphone, tablet PC, etc.) when video data is requested from a provider OTT via the communication network KN. The user can then select e.g. a specific data content (e.g. video film) on the mobile device MG, wherein said data content is transferred for playback on the output device AG (e.g. television screen). However, it is also possible to switch between the output device AG and a display of the mobile device MG or between two output devices AG, for example, or to use the output device AG and the mobile device MG or its display in parallel. For example, data contents such as e.g. a video film, advertising, etc. can be played on the output device AG while at the same time e.g. information about the video film, information about advertised products, a program preview and/or an electronic program guide, etc. can be requested and displayed on the mobile device. The user can therefore interact seamlessly and automatically with additional and/or complementary data contents, without e.g. output of selected data contents on the output device being disrupted or interrupted.

FIG. 2 schematically exemplifies a detailed structure of the system according to the invention, in particular the coupling component CDE.

The system according to the invention again comprises at least one mobile device MG (e.g. smartphone, tablet PC, etc.) and at least one output device AG such as e.g. a screen unit (e.g. television device, screen, display, etc.) in this case. The at least one mobile device MG is used to control an output and/or display of data contents. In this case, the data contents are provided as so-called over-the-top contents by OTT providers via a cellular communication network KN such as e.g. the Internet. The data contents offered by OTT providers (e.g. media companies, etc.) are either free of charge or chargeable in this case, and can be downloaded by the user via a simple web site and/or from an environment that is based on the Internet protocol (IP). The data contents are therefore supplied from an abstract IP-based infrastructure (the so-called IP cloud) comprising one or more OTT providers. The IP-based infrastructure of the OTT provider may comprise e.g. media databases in which the data contents (e.g. video data, audio data, etc.) are stored, databases containing supplementary information relating to the data contents (e.g. for protection of children and young persons, etc.), or a similar infrastructure.

For the purpose of procurement in particular, provision can also be made for a database ADB by means of which it is possible e.g. to check whether a user is authorized to procure specific data contents, i.e. whether said user has e.g. subscribed to, purchased, etc. said data contents. This permissions database ADB can be managed by the OTT provider of the data contents, for example, or operated by another OTT provider.

The system according to the invention further comprises a coupling component CDE, by means of which the devices MG, AG to be coupled are specified and a dynamic coupling LC of the devices MG, AG is then performed. The coupling component CDE, which is used for the purpose of decision-making for a dynamic coupling LC between at least one mobile device MG and at least one output device AG, in this case comprises a set of units which are involved in this decision-making and/or provide additional functions.

The coupling unit CDE comprises a trigger unit CIE, by means of which the coupling unit CDE is initiated by the mobile device MG in the first method step 1. The trigger unit CIE initiates a dynamic coupling process between a mobile device MG and an output unit. However, decoupling of the devices MG, AG is also started by the trigger unit CIE. For example, parameters which have been taken from and/or identified by the mobile device, and/or have changed, are used to initiate the trigger unit CIE. Parameters which can be used by the trigger unit CIE to initiate a coupling or decoupling process include e.g. a timer (e.g. date, time), movements made by the mobile device MG and detected by integrated sensors such as e.g. accelerometers, gyroscopes, etc., changes in field strength and/or Service Set Identifier (SSID) of a wireless LAN, changes in GPS data of the mobile device MG, specific user inputs (e.g. a so-called SWIPE command, etc.), an input for initial registration of an output device AG, etc.

If one or more such parameters or parameter changes are now identified by the trigger unit CIE, the decision process relating to a coupling LC or decoupling of devices MG, AG is initiated in the second method step 2. For this purpose, a first trigger T1 is sent from the trigger unit CIE to a proximity specification unit PDE. Additional measures (e.g. checking the proximity between mobile device MG and output devices AG on the basis of audible and/or inaudible audio signals, etc.) may also be initiated by the trigger unit CIE, in particular as a result of cascaded proximity estimation.

Using fuzzy logic methods in particular, the proximity specification unit PDE estimates a probability of a proximity between at least one mobile device MG and at least one output device AG, and whether a coupling LC can therefore be created or should be preserved. For the purpose of the proximity estimation, the proximity specification unit PDE makes use of parameters of a current environment pattern as supplied by the initiating mobile device MG. Additional measures for the proximity specification (e.g. audio signals, etc.) may be requested by the proximity specification unit PDE as a result of the cascaded approach. Parameters of a current environment pattern of a mobile device MG, on the basis of which a proximity to an output device AG can be specified for the purpose of a dynamic coupling LC, include e.g.: Service Set Identifier (SSID) of wireless LAN, field strength of wireless LAN, Bluetooth transmitter identification, Bluetooth field strength, an optical pattern (e.g. via a camera recording made by the mobile device MG), audio signals (audible, inaudible), volume of audio signals, noise pattern, orientation and/or coordinates/GPS data of the mobile device MG, 3G network (e.g. in the case of a smartphone) or the field strength of the 3G network, mobile network fingerprint, magnetic field strength, etc. It is essentially possible to use parameters which can easily be determined by means of sensors of the mobile device MG, e.g. camera, microphone, radio part, GPS, etc., and by means of which an environment can easily be recognized again.

Following activation by the trigger unit CIE, the proximity specification unit works in a cascaded manner. This means that the proximity specification unit PDE initially takes only a few parameters of the current environment pattern of the mobile device MG into consideration for the purpose of a proximity estimation, since the decision concerning proximity between mobile device MG and output device AG is usually time-critical and can also disrupt a rendition of data contents on the output unit AG, particularly when checking an existing coupling LC.

For the purpose of estimating the proximity more accurately, and also deciding whether output device AG is to be coupled to or decoupled from one or more mobile devices MG, a pattern recognition unit PRE is selected via a second trigger T2. The pattern recognition unit PRE compares a current environment pattern or parameters of a current environment pattern of the mobile device with a stored user-specific environment pattern which is used to identify the output device AG to be coupled, and a degree of correspondence of these environment patterns is determined. The user-specific environment patterns for the comparison are stored in a pattern recognition database CPR and retrieved from there by the pattern recognition unit PRE.

In this case, the pattern recognition unit PRE is a decision and comparison entity by means of which current situation and environment parameters of a mobile device MG are compared with user-specific situation and environment parameters from previous coupling scenarios and/or coupling decisions of a user. The decision and/or the estimation of a degree of correspondence between current and previous user-specific environment patterns or the corresponding parameters is performed by the pattern recognition unit PRE using fuzzy logic methods. The result of the decision process of the pattern recognition unit PRE is therefore an estimation of a degree of correspondence of a current coupling situation to previous coupling situations of a user or their mobile devices MG and output devices AG. Moreover, the pattern recognition unit PRE can also use e.g. results and/or errors from previous environment pattern comparisons for the estimation.

The proximity specification unit PDE and the pattern recognition unit PRE are therefore the decision-making units of the coupling component CDE and provide a means of estimating the probability of a mobile device MG being located in the (immediate) vicinity of an output device AG. If this probability is high, i.e. if the proximity specification unit PDE and the pattern recognition unit PRE return an appropriate estimate of proximity or degree of correspondence of the environment patterns, a dynamic coupling LC is created between the mobile device MG and the output device AG via the coupling component CDE, in particular via the proximity specification unit PDE, in the third method step 3. No coupling LC is created if an inadequate proximity is ascertained, and the coupling LC is terminated if an inadequate proximity between the devices MG, AG is detected in the case of an existing coupling LC. The respective status of the coupling between a mobile device MG and an output device AG is stored in a coupling status unit CSR in this case. By means of the coupling status unit CSR, it is therefore possible to specify the current status of a coupling LC (e.g. coupled, decoupled, etc.) between mobile devices MG and output devices AG of a coupling scenario, and the number of devices MG, AG involved.

The user-specific environment patterns for the comparison that is performed by the pattern recognition unit PRE are stored in the pattern recognition database CPR. The pattern recognition database CPR holds user-specific situation parameters of environment patterns of coupling scenarios, environment patterns, and possibly also decision outcomes/criteria of the proximity specification unit PDE and/or the pattern recognition unit PRE in respect of coupling and/or decoupling processes. These environment patterns, parameters, etc. are both provided by the coupling status unit CSR and can also be stored in the pattern recognition database CPR in the context of a registration procedure in which a user can register output devices AG to be coupled.

For example, interworking between pattern recognition unit PRE and pattern recognition database for the purpose of decision making takes place as follows. Decision data is requested by the pattern recognition unit PRE, e.g. from the proximity specification unit PDE, for the purpose of a coupling decision. Such decision data may comprise e.g. noise data, optical data, etc., which can be picked up by a sensor of the mobile device MG. In order to establish whether these parameters of a current environment pattern correspond largely to a known environment pattern of a known coupling scenario of the user, stored parameters and/or environment patterns from previous coupling scenarios (such as e.g. noises of the output unit, camera images such as e.g. floor pattern, WLAN field strength, etc.) are provided by the pattern recognition database CPR. The pattern recognition unit PRE then checks whether these stored parameters correspond to the currently ascertained parameters of the current environment pattern. The pattern recognition unit PRE then estimates a degree of correspondence or a probability that the present coupling situation corresponds largely to previous coupling situations. The result, i.e. the estimate of the degree of correspondence is then provided to the other units of the coupling component CDE, in particular to the proximity specification unit PDE.

A registration unit IPE is provided in the coupling component CDE for the purpose of first-time registration of an output device AG of a user, in order to allow dynamic coupling LC to the mobile devices MG of this user. An initial pairing between mobile devices MG and output devices AG of a dynamic coupling scenario is performed via the registration unit IPE. The registration unit IPE is particularly relevant, for example, when the user obtains a new output device AG, a new facility, etc. for use in a dynamic coupling scenario of the user.

The initial registration is likewise initiated by the trigger unit CIE, e.g. as a result of specific inputs by the user such as a so-called initial pairing command, a device ID, user ID, etc., and the registration unit IPE is then selected via the proximity specification unit PDE. The registration unit IPE requires a relatively large number of user inputs for the registration. By interacting with the desired output devices AG and/or mobile devices MG within a predefined time window, for example, the user can therefore specify which output devices AG and/or mobile devices MG must be associated with the coupling scenario. The corresponding user-specific environment patterns for the devices MG, AG are then registered by the registration unit IPE and saved in the pattern recognition database CPR. The registration unit IPE may also comprise various sub-units such as e.g. an initial pairing initiator, a time window synchronizer, a code generator, a code validator, interfaces to various devices MG, AG, a coupling confirmation unit, etc.

The coupling component CDE can also comprise a security unit YPRE. Information relating to parameters for the protection of children and young persons (e.g. age-related approvals of the data contents, adult-restricted content, etc.) can be stored in the security unit YPRE and made available to the other units of the coupling component CDE. The security unit YPRE allows checks to be performed in respect of the coupling LC, particularly during the fourth method step 4, in response to a selection and/or before or during display of in particular age-restricted data contents on an existing coupling LC, such that these data contents cannot be inadvertently consumed by minors, for example. In this case, the check of the coupling LC can be provoked e.g. by raising or lowering a threshold value for the first trigger T1 such that the check of the coupling LC is performed on the basis of the age-related approval, e.g. a check of the coupling LC is always performed in the case of an approved age rating of 18 years, while in the case of a lower approved age rating, the threshold value for the check is correspondingly lower or higher (according to the threshold value being used).

The coupling component CDE further comprises an input device checking unit AIE. The input device checking unit AIE is used to track and monitor the presence of alternative input devices (e.g. remote control, etc.) and any inputs and activities of an alternative input device that may be present. In particular, the input device checking unit AIE checks the extent to which an alternative input device or inputs therefrom influence the dynamic coupling between the respective mobile device MG and the output unit AG. For this purpose, the input device checking unit AIE interacts with the alternative input devices such as e.g. remote control, infrared receivers, home media gateways, etc., holds their respective status and analyzes their inputs. Therefore the input device checking unit AIE can very easily identify additional inputs, e.g. from a remote control or from the home media gateway, which result in the immediate creation or termination of a dynamic coupling LC, for example.

The coupling component CDE can also comprise an authorization interface AAI, by means of which it can be checked in the fourth method step 4, e.g. by querying a permissions database ADB, whether a user is authorized to procure specific data contents (i.e. charges have been paid for the data contents if applicable, etc.) or whether the data contents may lawfully be played (i.e. the provider has the relevant permissions for the distribution of the data contents).

By virtue of the method and system according to the invention, a user can therefore easily use their mobile devices MG to control the output and display of data contents, which are available in a cellular communication network KN and/or offered by OTT providers, on a desired output device AG. A direct connection between mobile device MG and output devices AG is not required. By virtue of the method and/or system according to the invention, a coupling LC between the devices MG, AG is automatically and dynamically created by the coupling component CDE if a corresponding proximity exists between these devices MG, AG. If the mobile device MG is removed from the vicinity of the output device AG, this is detected by the coupling component CDE due to a change in the current environment parameters, and the coupling LC is automatically terminated again in the event of a corresponding proximity estimation result and degree of correspondence to a stored user-specific environment pattern (i.e. low probability of correspondence).

1.-20. (canceled)

21. A method for dynamically coupling at least one mobile device controlling a selection and output of data contents to at least one output device, comprising:
providing the data contents via a cellular communication network;
initiating a coupling component by the at least one mobile device via the cellular communication network;
determining the at least one output device to be coupled by the coupling component based on a stored user-specific environment pattern;
dynamically coupling the at least one output device to the at least one mobile device;
identifying a current environment pattern by the at least one mobile device for initiating the coupling component and determining the at least one output device to be coupled; and
estimating a proximity between the at least one mobile device and the at least one output device by a proximity specification unit based on parameters of the current environment pattern,
wherein the parameters of the current environment pattern comprise a field strength of wireless LAN and/or Bluetooth, a transmitter identification of wireless LAN and/or Bluetooth, an audible audio signal and/or an inaudible audio signal and/or optical environment parameters and/or position data.

22. The method as claimed in claim 21, wherein fuzzy logic methods and/or probability reckoning models are used by the proximity specification unit to obtain a proximity estimate.

23. The method as claimed in claim 22, wherein the parameters of the current environment pattern are compared with the stored user-specific environment pattern by a pattern recognition unit of the coupling component for determining a degree of correspondence of the parameters of the current environment pattern to the stored user-specific environment.

24. The method as claimed in claim 23, wherein the fuzzy-logic methods are used by the pattern recognition unit for determining the degree of correspondence.

25. The method as claimed in claim 24, wherein the at least one output device to be coupled is registered with an associated user-specific environment pattern by a registration unit of the coupling component.

26. The method as claimed in claim 21, wherein the user-specific environment pattern associated with the at least one output device to be coupled is saved in a pattern recognition database of the coupling component.

27. The method as claimed in claim 21, wherein a status of the coupling between the at least one mobile device and the at least one output device to be coupled is saved in a coupling status unit of the coupling component.

28. The method as claimed in claim 21, wherein an additional check of the coupling between the at least one mobile device and the at least one output device is initiated via a security unit of the coupling component for specific data contents comprising age-restricted data contents.

29. The method as claimed in claim 21, wherein a presence of an additional input device comprising a remote control for the at least one output device is checked by an input device checking unit.

30. The method as claimed in claim 21, wherein authorizations relating to a procurement of data contents are checked by the coupling component via an authorization interface.

31. A system for dynamically coupling at least one mobile device controlling a selection and output of data contents to at least one output device, comprising:
a cellular communication network for supplying the data contents;
a coupling component for determining the at least one output device to be coupled based on a stored user-specific environment and dynamically coupling the at least one output device to the at least one mobile device;
a trigger unit for initiating the coupling;
a proximity specification unit for estimating a proximity between the at least one mobile device and the at least one output device; and
a pattern recognition unit for comparing the stored user-specific environment pattern with parameters of a current environment pattern identified by the at least one mobile device,
wherein the parameters of the current environment pattern comprise a field strength of wireless LAN and/or Bluetooth, a transmitter identification of wireless LAN and/or Bluetooth, an audible audio signal and/or an inaudible audio signal and/or optical environment parameters and/or position data of the mobile device in particular.

32. The system as claimed in claim 31, wherein the coupling component comprises a registration unit for registering output devices to be coupled and a pattern recognition database for saving the user-specific environment patterns.

33. The system as claimed in claim 31, wherein the coupling component comprises a coupling status unit for saving a status of the coupling.

34. The system as claimed in claim 31, wherein the coupling component further comprises:
a security unit for initiating an additional check of the coupling for specific data contents comprising age-restricted data contents,
an input device checking unit for checking a presence of an additional input device comprising a remote control belonging to the at least one output device, and
an authorization interface for checking an authorization relating to a procurement of the data contents.

35. The system as claimed in claim 31, wherein the at least one mobile device comprises a smartphone, a tablet PC and/or a laptop.

36. The system as claimed in claim 31, wherein the at least one output device comprises a screen unit of a TV device, a smartphone, a tablet PC or a laptop for displaying the data contents.

37. The system as claimed in claim 31, wherein the cellular communication network comprises an Internet.
